(19) United States
(12) Patent Application Publication
(10) Pub. No.: US 2026/0135462 A1
(43) Pub. Date: May 14, 2026

(54) HIGH-POWER POWER CONVERSION DEVICE

(71) Applicant: MetaPWR Electronics Co., Ltd., Shanghai (CN)

(72) Inventors: Da Jin, Shanghai (CN); Yahong Xiong, Shanghai (CN)

(73) Assignee: MetaPWR Electronics Co., Ltd., Shanghai (CN)

(21) Appl. No.: 19/385,175

(22) Filed: Nov. 11, 2025

(30) Foreign Application Priority Data
Nov. 11, 2024 (CN) 202411601879.5

(51) Int. Cl. H02M 1/00; H02M 3/00; H02M 3/335

(52) U.S. Cl. CPC H02M 1/0054; H02M 3/003; H02M 3/01; H02M 3/33573; H02M 3/33592

(57) ABSTRACT

The application discloses a circuit topology and a control method for a high-power application of an input voltage to an output voltage with a high step-down ratio; the circuit topology has a low switching loss and a high conversion efficiency in a high-frequency switching occasion. The present application further provides a power conversion device using the circuit topology, which provides a device layout setting of the power conversion device and a winding mode of the transformer. Under the condition that high-power output is met, the volume of the power conversion device is further reduced, and the steady-state performance and dynamic performance of the conversion device are improved.

### CROSS-REFERENCE TO RELATED APPLICATIONS

This application claims the priority benefit of Chinese patent application CN202411601879.5 filed on Nov. 11, 2024. The entirety of the above-mentioned patent application is hereby incorporated by reference herein and made a part of this specification.

### BACKGROUND

With the development of artificial intelligence, the power requirements of intelligent data processing chips, such as GPU/CPU/NPU, etc. (collectively, xPU) are increasingly high, so that the power of the server is increased, and the input voltage of the server gradually changes from 12V to 48V. Therefore, the step-down ratio of the input voltage to the output voltage is higher and higher. The required power of the xPU is also higher and higher. In order to obtain a high input/output voltage gain ratio and a high-power application, there is an urgent need for a circuit architecture with high conversion efficiency and a conversion device.

According to the solution of the power conversion device having a high input-to-output voltage gain ratio, the high-voltage full-bridge unit input end is connected in series, so as to reduce the input voltage of each high-voltage full-bridge unit, thereby reducing the switching loss of the power switch device in each high-voltage full-bridge unit under high-frequency switching, and improving the conversion efficiency of the overall power conversion device; the high-voltage side is connected in series, which reduces the voltage difference of transformer, can obtain better EMI characteristics, and on the other hand, the low-voltage full-bridge unit is connected in parallel to meet the high-power requirements of the conversion device.

### SUMMARY

In view of the above, one of the objectives of the application is to provide a high-power power conversion device, comprising a high-voltage unit, a low-voltage unit, an input capacitor, an output capacitor, an input positive terminal, an input negative terminal, an output positive terminal and an output negative terminal, wherein the high-voltage unit comprises a first high-voltage unit and a second high-voltage unit, the low-voltage unit comprises a first low-voltage unit and a second low-voltage unit, and the input capacitor comprises a first input capacitor and a second input capacitor;
each high-voltage unit comprises a switch and a high-voltage winding; the two high-voltage windings are respectively a first high-voltage winding and a second high-voltage winding; each low-voltage unit comprises a switch and a low-voltage winding; the two low-voltage windings are respectively a first low-voltage winding and a second low-voltage winding; the two high-voltage windings and the two low-voltage windings are coupled by means of a same magnetic core assembly;
the first high-voltage unit and the second high-voltage unit are electrically connected in series to an input midpoint, and the two high-voltage units are connected in series and then connected across the input positive terminal and the input negative terminal; the first input capacitor and the first high-voltage unit are connected in parallel and then connected across the input positive terminal and the input midpoint, and the second input capacitor and the second high-voltage unit are connected in parallel and then connected across the input midpoint and the input negative terminal;
the first low-voltage unit and the second low-voltage unit are electrically connected in parallel between the output positive terminal and the output negative terminal; the output capacitor is connected across the output positive terminal and the output negative terminal;

the power conversion device further comprises a substrate, the substrate comprising an upper surface and a lower surface opposite to each other; the substrate further comprises a plurality of hole grooves, the plurality of hole grooves penetrate the upper surface and the lower surface; the magnetic core assembly comprises a magnetic column, a side column, an upper magnetic cover and a lower magnetic cover; the magnetic column and the side column respectively pass through the plurality of hole grooves, and the upper magnetic cover and the lower magnetic cover are respectively assembled to the substrate from the upper surface and the lower surface; the magnetic core assembly further comprises a first side and a third side opposite to each other, and a second side and a fourth side opposite to each other;
the switch in the high voltage unit is disposed adjacent to the first side of the magnetic core assembly, the switch in the first low voltage unit is disposed adjacent to the second side of the magnetic core assembly, and the switch in the second low voltage unit is disposed adjacent to the fourth side of the magnetic core assembly.

Preferably, two ends of each of the high-voltage windings are disposed adjacent to the first side of the magnetic core assembly; the switch and both ends of the low-voltage winding in the first low-voltage unit are disposed adjacent to the second side of the magnetic core assembly, and the switch and both ends of the low-voltage winding in the second low-voltage unit are disposed adjacent to the fourth side of the magnetic core assembly.

Preferably, the magnetic column comprises a first magnetic column, a second magnetic column, a third magnetic column and a fourth magnetic column; the side column comprises a first side column and a second side column, the first side column is arranged adjacent to the first side of the magnetic core assembly, and the second side column is arranged adjacent to the third side of the magnetic core assembly; the four magnetic columns are arranged between the first side column and the second side column in a 2×2 array; the first magnetic column and the third magnetic column are arranged adjacent to the first side column, the second magnetic column and the fourth magnetic column are arranged adjacent to the second side column, the first magnetic column and the second magnetic column are arranged adjacent to the second side of the magnetic core assembly, and the third magnetic column and the fourth magnetic column are arranged adjacent to the fourth side of the magnetic core assembly.

Preferably, a first end of the first low-voltage winding is arranged between the first magnetic column and the second magnetic column, a second end of the first low-voltage winding is respectively provided between the first side column and the first magnetic column, and between the second side column and the second magnetic column; and the first low-voltage winding is wound around the first magnetic column and the second magnetic column in opposite directions from the first end to the second end, respectively; a first end of the second low-voltage winding is arranged between the third magnetic column and the fourth magnetic column, a second end of the second low-voltage winding is respectively arranged between the first side column and the third magnetic column, and between the second side column and the fourth magnetic column, and the second low-voltage winding is wound around the third magnetic column and the fourth magnetic column in opposite directions from the first end to the second end, respectively; the winding direction of the first low voltage winding from the first end to the second end around the first magnetic column is opposite to the winding direction of the second low voltage winding from the first end to the second end around the third magnetic column.

Preferably, the substrate comprises a plurality of wiring layers; the first high-voltage winding is wound at least two turns around the first magnetic column and the second magnetic column in opposite directions from the first end to the second end, respectively; the second high-voltage winding is wound at least two turns around the third magnetic column and the fourth magnetic column in opposite directions from the first end to the second end, respectively; the winding direction of the first high-voltage winding on the first magnetic column and the winding direction of the second high-voltage winding on the third magnetic column are opposite.

Preferably, the high-voltage winding is wound at least two layers, the first high-voltage winding from the first end to the second end is first wound half turn clockwise around the first magnetic column in a first layer, and then wound one turn counterclockwise around the second magnetic column, and then reached the second layer through a second via; and on a second layer, it is first wound one turn around the second magnetic column in a counterclockwise direction, then wound one turn clockwise around the first magnetic column, and then returned to the first layer through a first via; and on the first layer, it is wound a half turn clockwise around the first magnetic column to reach the second end; the second high-voltage winding from the first end to the second end is first wound a half turn counterclockwise around the third magnetic column in the first layer, and then reached the second layer through a third via; and in the second layer it is wound one turn around the third magnetic column in a counterclockwise direction, then wound one turn clockwise around the fourth magnetic column, and then returned to the first layer through a fourth via, and on the first layer it is wound one turn clockwise around the fourth magnetic column, and then is wound a half turn around the third magnetic column counterclockwise back to the second end.

Preferably, the two high-voltage windings are disposed on two layers of the plurality of wiring layers, and two ends of the two high-voltage windings are disposed on different wiring layers.

Preferably, the switch in each high-voltage unit comprises a first upper switch, a second upper switch, a first middle switch and a second middle switch, and each high-voltage unit further comprises a resonant capacitor, the resonant capacitors are a first resonant capacitor and a second resonant capacitor; in the first high-voltage unit, the first upper switch and the first middle switch are electrically connected in series to a first upper node, and are connected in series between the input positive terminal and the input midpoint, the second upper switch and the second middle switch are electrically connected in series to a second upper node and are connected in series between the input positive terminal and the input midpoint, the first resonant capacitor and a first end of the first high-voltage winding are connected in series, and then connected in series between the first upper node and the second upper node, and a second end of the first high-voltage winding is electrically connected to the second upper node; in the second high-voltage unit, the first upper switch and the first middle switch are electrically connected in series to a third upper node, and are connected in series between the input midpoint and the input negative terminal, the second upper switch and the second middle switch are electrically connected in series to a fourth upper node, and are connected in series between the input midpoint and the input positive terminal, the second resonant capacitor and a first end of the second high-voltage winding are connected in series, and are connected in series between the third upper node and the fourth upper node, and a second end of the second high-voltage winding is electrically connected to the fourth upper node.

Preferably, the switch in each of the low-voltage units comprises a first lower switch, a second lower switch, a third lower switch, and a fourth lower switch; in the first low-voltage unit, the first lower switch and the second lower switch are electrically connected in series to a first lower node, and are connected in series between the output positive terminal and the output negative terminal; the third lower switch and the fourth lower switch are electrically connected in series to a second lower node, and are connected in series between the output positive terminal and the output negative terminal; a first end of the first low-voltage winding is electrically connected to the first lower node, and a second end of the first low-voltage winding is electrically connected to the second lower node; in the second low-voltage unit, the first lower switch and the second lower switch are electrically connected in series to a third lower node, and are connected in series between the output positive terminal and the output negative terminal; the third lower switch and the fourth lower switch are electrically connected in series to a fourth lower node, and are connected in series between the output positive terminal and the output negative terminal; a first end of the second low-voltage winding is electrically connected to the third lower node; and a second end of the second low-voltage winding is electrically connected to the fourth lower node.

Preferably, the high-power power conversion device, further comprising a first control signal, a second control signal, a third control signal and a fourth control signal, wherein the duty ratios of the first control signal and the second control signal are both 50% with a phase shift of 180 degrees; the third control signal is complementary to the first control signal, and the fourth control signal is complementary to the second control signal.

Preferably, the first control signal is used for controlling turn-on and turn-off of the first upper switch and the second middle switch of the two high-voltage units; the second control signal is used for controlling turn-on and turn-off of the second upper switch and the first middle switch in the two high-voltage units; the third control signal is used for controlling turn-on and turn-off of the second lower switch and the third lower switch of the two low-voltage units; the fourth control signal is used for controlling turn-on and turn-off of the first lower switch and the fourth lower switch in the two low-voltage units.

Preferably, the second end of each high-voltage winding and the second end of each low-voltage winding have the same polarity.

Preferably, the first resonant capacitor is disposed between the switch in the first high-voltage unit and the first side of the magnetic core assembly, and the second resonant capacitor is disposed between the switch in the second high-voltage unit and the first side of the magnetic core assembly.

Preferably, the first high-voltage unit is connected across the input positive terminal and the input midpoint, and the second high-voltage unit is connected across the input midpoint and the input negative terminal; the first input capacitor is disposed adjacent to the switch in the first high-voltage unit, and the second input capacitor is disposed adjacent to the switch in the second high-voltage unit.

Preferably, the switch in the two high-voltage units are disposed on the upper surface of the substrate, and the first input capacitor and the second input capacitor are disposed on the lower surface of the substrate; projections on the same horizontal plane of the first input capacitor and the switch in the first high-voltage unit are at least partially overlapped, and projections on the same horizontal plane of the second input capacitor and the switch in the second high-voltage unit are at least partially overlapped.

Preferably, a part of the switches of the two high-voltage units is arranged on the upper surface of the substrate, and another part of the switches of the two high-voltage units is arranged on the lower surface of the substrate.

Preferably, the switch of the two low-voltage units is arranged on the upper surface of the substrate, and the output capacitor is arranged on the lower surface of the substrate; and projections on the same horizontal plane of the output capacitor and the switch in each of the low-voltage units are at least partially overlapped.

Preferably, a part of the switches of the two low-voltage units is arranged on the upper surface of the substrate, and another part of the switches of the two low-voltage units is arranged on the lower surface of the substrate.

Preferably, the high-power power conversion device, further comprising a power input and a power output, wherein the power input is disposed adjacent to the switch in the high-voltage unit, and the power output is disposed adjacent to the third side of the magnetic core assembly.

Preferably, a first gap exists between the first side column and the second side of the magnetic core assembly, the switch in the first high voltage unit is arranged adjacent to the first gap, and two ends of the first high voltage winding are electrically connected to the switch in the first high voltage unit through the first gap; a second gap exists between the first side column and the fourth side of the magnetic core assembly, the switch in the second high voltage unit is disposed adjacent to the second gap, and two ends of the second high voltage winding are electrically connected to the switch in the second high voltage unit through the second gap.

Preferably, the first side column comprises two first sub-side columns, a first gap exists between the second side of the magnetic core assembly and an adjacent first sub-side column, the switch in the first high-voltage unit is arranged adjacent to the first gap, and two ends of the first high-voltage winding are electrically connected to the switch in the first high-voltage unit through the first gap; a second gap exists between the two first sub-side columns, the switch in the second high-voltage unit is arranged adjacent to the second gap, and two ends of the second high-voltage winding are electrically connected to the switch in the second high-voltage unit through the second gap.

Preferably, the first lower switch, the second lower switch, the third lower switch, and the fourth lower switch in each low-voltage unit comprise two switches electrically connected in parallel respectively, and the first lower switch, the second lower switch, the third lower switch and the fourth lower switch in each low-voltage unit are sequentially arranged from the middle of the second side or the fourth side to the first side and the third side.

Preferably, the switches in the first low-voltage unit are disposed along the second side of the magnetic core assembly, the switches in the second low-voltage unit are disposed along the fourth side of the magnetic core assembly.

Compared with the prior art, the application has the following beneficial effects:
(1) The circuit topology of the present application is applicable to an application which has a high step-down ratio of an input voltage to an output voltage; and the circuit topology has low switching loss and high conversion efficiency in the case of high-frequency switching; in the present application, by connecting the input ends of the two high-voltage full-bridge units in series and connecting the two low-voltage full-bridge units in parallel, the input voltage of each high-voltage full-bridge unit is reduced, thereby reducing the switching loss of the power switch in each high-voltage full-bridge unit, improving the conversion efficiency of each full-bridge unit and the entire power conversion circuit, and improving the EMI characteristics of the entire power conversion circuit;
(2) The layout arrangement of the power conversion device and the winding mode of the transformer of the present application reduce the volume of the power conversion device, and improve the steady-state performance and dynamic performance of the conversion device. The winding method of the transformer winding enables the high-voltage full-bridge switch to be disposed adjacent to both ends of the high-voltage winding, the low-voltage full-bridge switch is disposed adjacent to both ends of the low-voltage winding, the parasitic resistance on the power current path is reduced, the output voltage is particularly suitable for the high step-down ratio of the input voltage to the output voltage, and the output is a low-voltage high-current occasion; meanwhile, the magnetic flux distribution characteristics of the transformer magnetic core can be improved, and the magnetic core loss of the transformer is reduced.

### BRIEF DESCRIPTION OF THE DRAWINGS

FIG. 1 is a circuit topology of a power conversion device;

FIG. 2 is a control timing sequence;

FIG. 3A to FIG. 3C are winding manners of a structure and a winding of a magnetic core assembly;

FIG. 4A to FIG. 4C are schematic structural diagrams of a power conversion device.

### DESCRIPTION OF THE EMBODIMENTS

One of the cores of the present application is to provide a circuit topology, which is applicable to an application which has a high step-down ratio of the input voltage to an output voltage. The circuit topology has low switching loss and high conversion efficiency in high-frequency switching occasion. Another core of the present application is to provide a power conversion device, which provides a layout arrangement of the power conversion device and a winding mode of the transformer, reduces the volume of the power conversion device, and improves the steady-state performance and dynamic performance of the conversion device.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

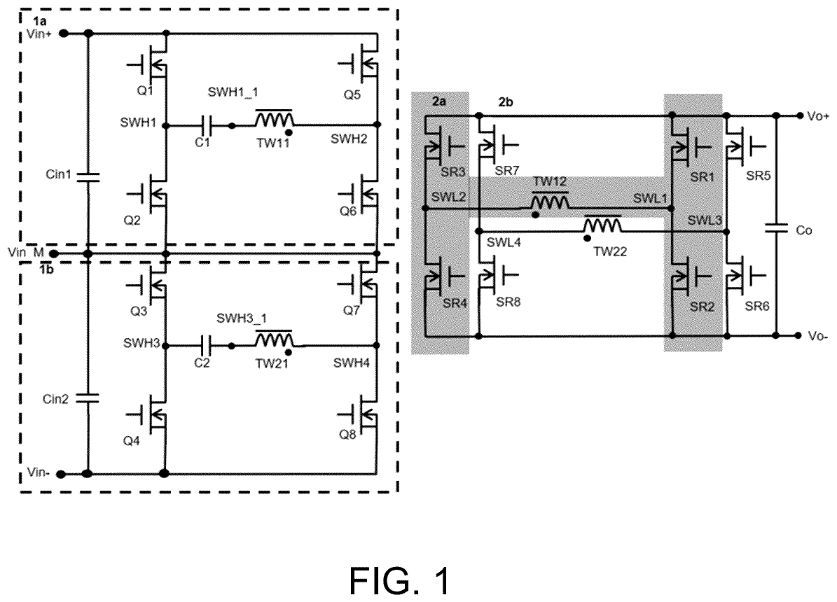

The circuit topology is shown in FIG. 1, and includes two high-voltage full-bridge units 1a and 1b, two low-voltage full-bridge units 2a and 2b, input capacitors Cin1 and Cin2, and an output capacitor Co. The input terminals of the two high-voltage full-bridge units 1a and 1b are connected in series, and the output terminals of the two low-voltage full-bridge units 2a and 2b are connected in parallel. The input terminals of the two high-voltage full-bridge units 1a and 1b are connected in series to the input terminal (i.e. the input positive terminal Vin+ and the input negative terminal Vin−), and the output terminals of the two low-voltage full-bridge units 2a and 2b (i.e. the output positive terminal Vo+ and the output negative terminal Vo−) are connected in parallel. The high-voltage full-bridge unit 1a comprises switches Q1, Q2, Q5 and Q6, a high-voltage winding TW11 and a resonant capacitor C1; the first upper switch Q1 and the first middle switch Q2 are connected in series to a first upper node SWH1, and are connected between the input positive terminal Vin+ and the input midpoint Vin_M after being connected in series; the second upper switch Q5 and the second middle switch Q6 are connected in series to a second upper node SWH2, and the second upper switch Q5 and the second middle switch Q6 are connected in series between the input positive terminal Vin+ and the input midpoint Vin_M. The resonant capacitor C1 and the high-voltage winding TW11 are connected in series to a series point SWH1_1, and are connected in series between the first upper node SWH1 and the second upper node SWH2. The high-voltage full-bridge unit 1b comprises switches Q3, Q4, Q7 and Q8, a high-voltage winding TW21 and a resonant capacitor C2; the first upper switch Q3 and the first middle switch Q4 are connected in series to a third upper node SWH3, and are connected in series between the input midpoint Vin_M and the input negative terminal Vin−; the second upper switch Q7 and the second middle switch Q8 are connected in series to a fourth upper node SWH4, and are connected in series between the input midpoint Vin_M and the input negative terminal Vin−. The resonant capacitor C2 and the high-voltage winding TW21 are connected in series to a series point SWH3_1, and are connected in series between the third upper node SWH3 and the fourth upper node SWH4. The high voltage full bridge circuit 1a and the high voltage full bridge circuit 1b are connected in series to the input midpoint Vin_M, and are connected in series between the input positive terminal Vin+ and the input negative terminal Vin−. Furthermore, the drain of the first upper switch Q1 and the drain of the second upper switch Q5 are electrically connected to the input positive terminal Vin+; the source of the first middle switch Q2, the source of the second middle switch Q6, the drain of the first upper switch Q3, and the drain of the second upper switch Q7 are electrically connected to the input midpoint Vin_M, and the source of the middle switch Q4 and the source of the second middle switch Q8 are electrically connected to the input negative terminal Vin−.

The low-voltage full-bridge unit 2a comprises switches SR1, SR2, SR3 and SR4 and a low-voltage winding TW12; the first lower switch SR1 and the second lower switch SR2 are connected in series to a first lower node SWL1, and are connected in series between the output positive terminal Vo+ and the output negative terminal Vo−; the third lower switch SR3 and the fourth lower switch SR4 are connected in series to a second lower node SWL2, and the third lower switch SR3 and the fourth lower switch SR4 are connected in series between the output positive terminal Vo+ and the output negative terminal Vo−; and the low-voltage winding TW12 is connected between the first lower node SWL1 and the second lower node SWL2. The low-voltage full-bridge unit 2b comprises switches SR5, SR6, SR7 and SR8, and a low-voltage winding TW22; the first lower switch SR5 and the second lower switch SR6 are connected in series to a third lower node SWL3, and are connected in series between the output positive terminal Vo+ and the output negative terminal Vo−; the third lower switch SR7 and the fourth lower switch SR8 are connected in series to a fourth lower node SWL4, and the third lower switch SR7 and the fourth lower switch SR8 are connected in series between the output positive terminal Vo+ and the output negative terminal Vo−; and the low-voltage winding TW22 is connected between the third lower node SWL3 and the fourth lower node SWL4. In detail, the drain of the third lower switch SR3, the drain of the third lower switch SR7, the drain of the first lower switch SR1, and the drain of the first lower switch SR5 are all electrically connected to the output positive terminal Vo+, the source of the second lower switch SR2, the source of the second lower switch SR6, the source of the fourth lower switch SR4, and the source of the fourth lower switch SR8 are all electrically connected to the output negative terminal Vo−. The source of each first lower switch is electrically connected to the drain of a corresponding second lower switch, and the source of each third lower switch is electrically connected to the drain of a corresponding fourth lower switch.

The magnetic assembly comprises high-voltage windings TW11 and TW21, the low-voltage windings TW12 and TW22, the high-voltage windings and the low-voltage windings are coupled to each other, and are wound on the same magnetic core assembly. The high-voltage full-bridge units, the low-voltage full-bridge units, and the high-voltage and low-voltage full-bridge units are coupled by means of the magnetic assembly. The output capacitor Co is connected between the output positive terminal Vo+ and the output negative terminal Vo−. A second end (SWH2) of the high-voltage winding TW11 and a second end (SWH4) of the high-voltage winding TW21, a second end (SWL2) of the low-voltage winding TW12 and a second end (SWL4) of the low-voltage winding TW22 are have the same polarity, and are marked as point ends. The input capacitor Cin1 is connected between the input positive terminal Vin+ and the input midpoint Vin_M, and the input capacitor Cin2 is connected between the input midpoint Vin_M and the input negative terminal Vin−.

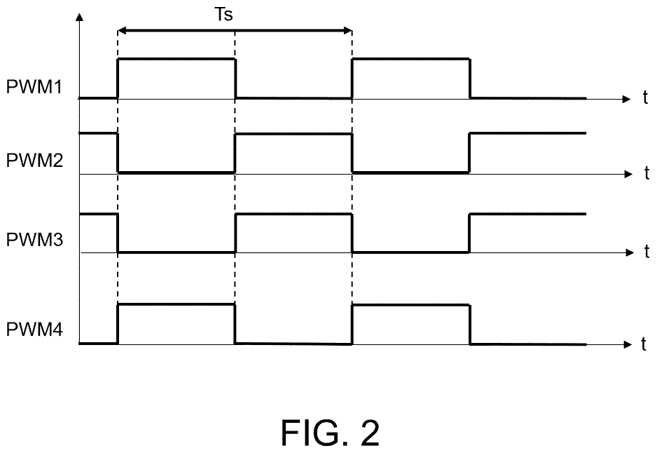

In this embodiment, the circuit topology adopts four control signals, as shown in FIG. 2. The four control signals are respectively a first control signal PWM1, a second control signal PWM2, a third control signal PWM3, and a fourth control signal PWM4, wherein the duty cycles of the first control signal PWM1 and the second control signal PWM2 are equal with a phase shift of 180 degrees; a dead time (not shown) is further comprised between the first control signal PWM1 and the second control signal PWM2; the third control signal PWM3 is complementary to the first control signal PWM1, and the fourth control signal PWM4 is complementary to the second control signal PWM2. In this embodiment, the duty cycle of the first control signal PWM1 and the duty cycle of the second control signal PWM2 are both approximately equal to 50% (ignoring the dead time, the duty cycle is 50%.) .

The first control signal PWM1 is used for controlling the turning on and off of the first upper switch Q1 and Q3, the second middle switch Q6 and Q8; the second control signal PWM2 is used for controlling the turning on and off of the first middle switch Q2 and Q4 and the second upper switch Q5 and Q7; the third control signal PWM3 is used for controlling the turn-on and turn-off of the second lower switch SR2 and the SR6 and the third lower switch SR3 and SR7; and the fourth control signal PWM4 is used for controlling the turn-on and turn-off of the first lower switch SR1 and the SR5 and the fourth lower switch SR4 and SR8.

In the present embodiment, by connecting the input ends of the two high-voltage full-bridge units in series, the input voltage of each high-voltage full-bridge unit is reduced, thereby reducing the switching loss of the power switches in each high-voltage full-bridge unit, and improving the conversion efficiency of each high-voltage full-bridge unit and the entire power conversion circuit. By means of connecting the output ends of the two low-voltage full-bridge units in parallel, the output current and the output power of the power conversion apparatus are improved.

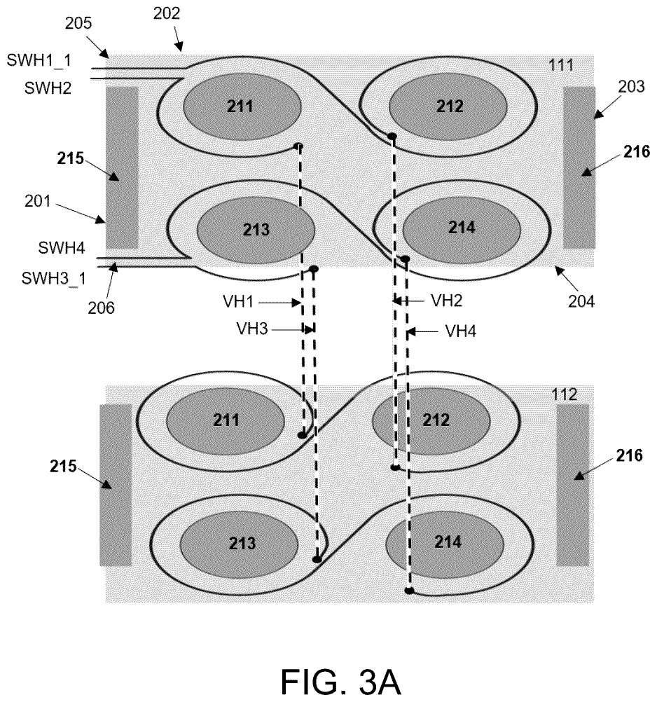

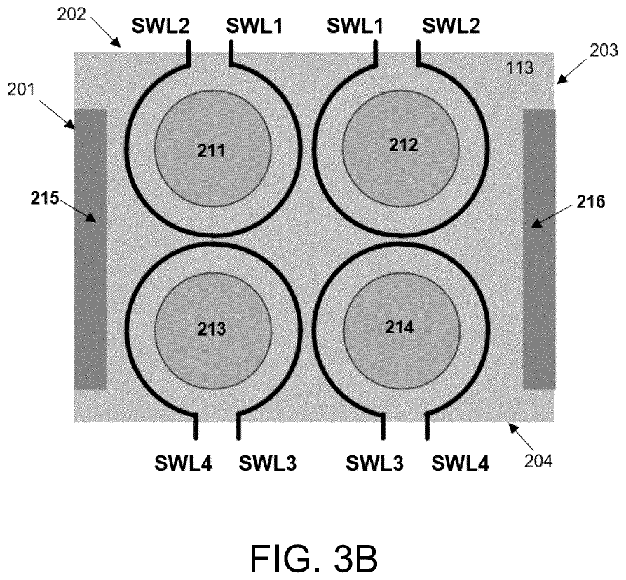

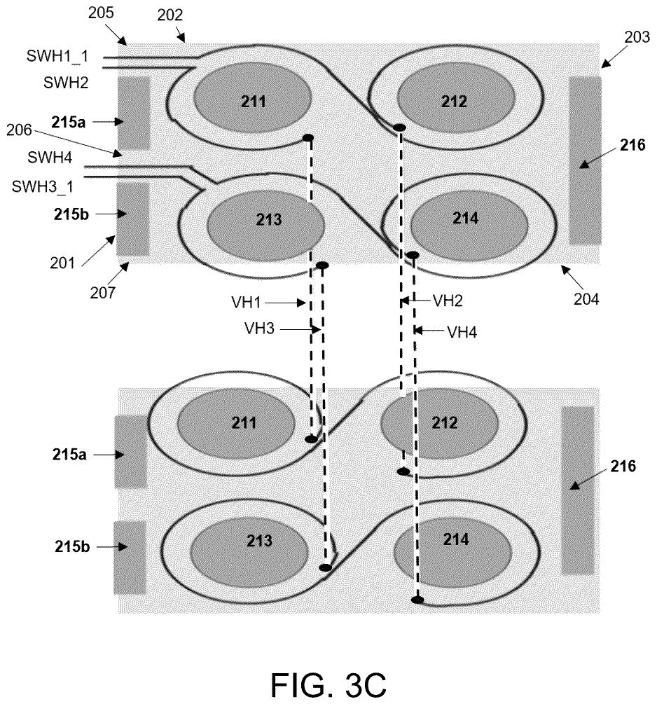

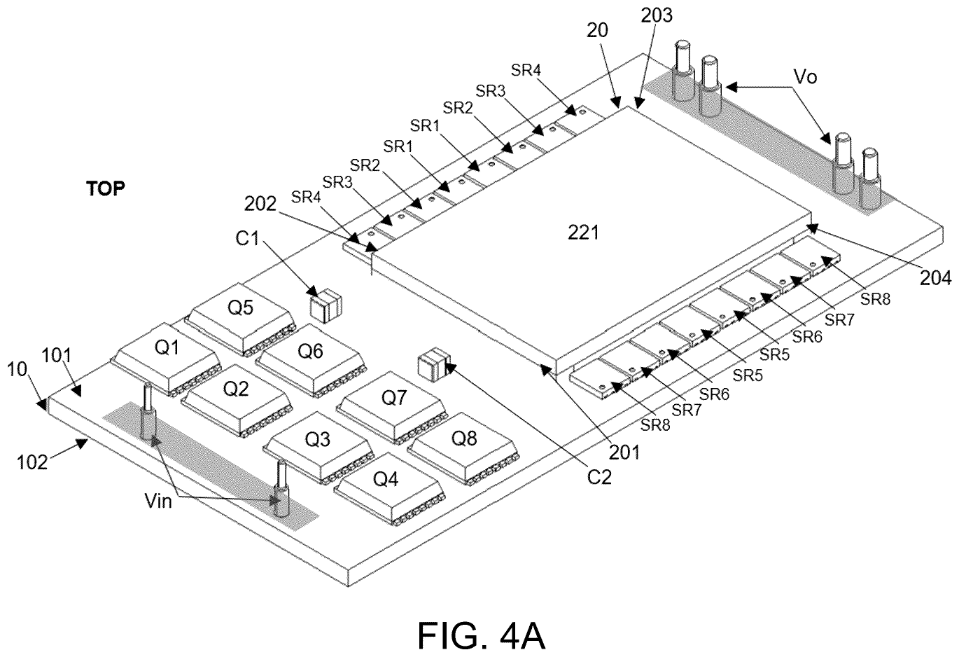

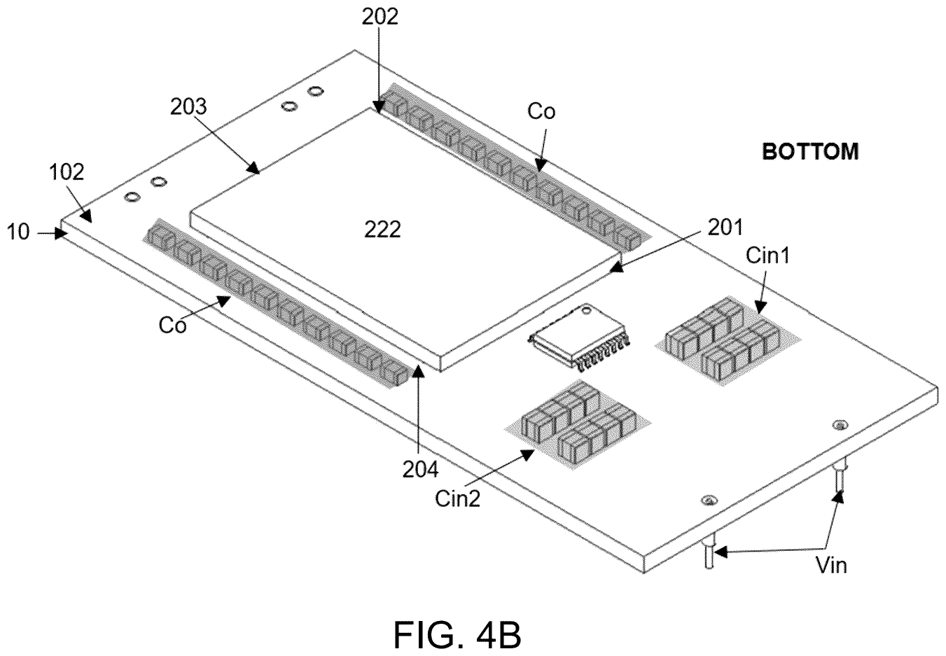

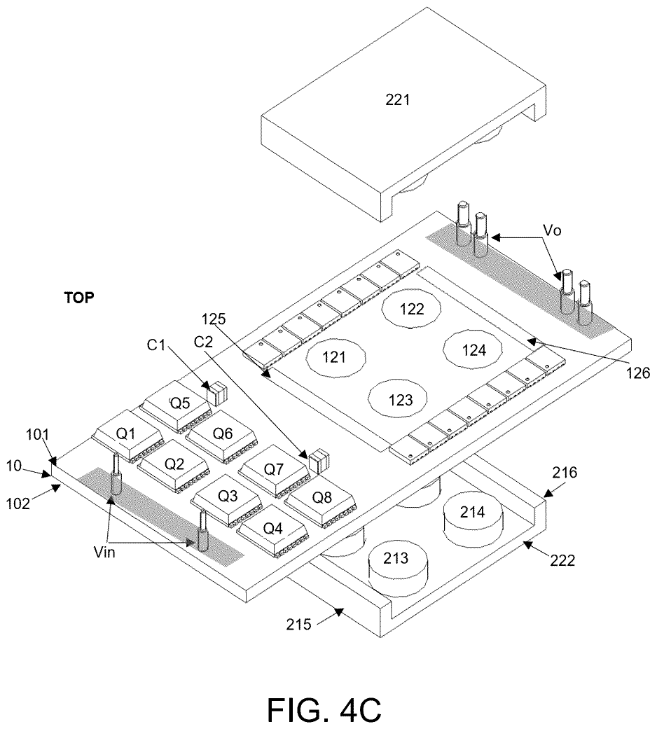

A power conversion device and a winding manner of the magnetic assembly and a structure of the magnetic core assembly are also disclosed. The winding manner of the winding is shown in FIG. 3A to FIG. 3C, and a schematic structural diagram of the power conversion device may be shown in FIG. 4A to FIG. 4C. FIG. 3A and FIG. 3C are winding manners of the high-voltage windings TW11 and TW21, and FIG. 3B is a winding manner of the low-voltage windings TW12 and TW22. The magnetic core assembly comprises a first magnetic column 211, a second magnetic column 212, a third magnetic column 213, a fourth magnetic column 214, a first side column 215 and a second side column 216; meanwhile, referring to FIG. 4B, the magnetic core assembly further comprises an upper magnetic cover 221 and an lower magnetic cover 222, a first side 201 and a third side 203 opposite to each other, a second side 202 and a fourth side 204 opposite to each other. The first side column 215 is arranged adjacent to the first side 201, and the second side column 216 is arranged adjacent to the third side 203; there is a gap 205 between the first side column 215 and the second side 202 and a gap 206 between the first side column 215 and the forth side 204. The four magnetic columns are all arranged between the first side column 215 and the second side column 216; the first magnetic column 211 and the second magnetic column 212 are both arranged adjacent to the second side 202, and the third magnetic column 213 and the fourth magnetic column 214 are both arranged adjacent to the fourth side 204; the first magnetic column 211 and the third magnetic column 213 are both arranged adjacent to the first side column 215, and the second magnetic column 212 and the fourth magnetic column 214 are both arranged adjacent to the second side column 216; that is, the four magnetic columns are arranged in an array of 2×2. Both the high-voltage winding and the low-voltage winding are wound on a same substrate 10 (see FIG. 4A).

Both the first end and the second end of the two high-voltage windings are arranged adjacent to the first side 201, the first end and the second end of the high-voltage winding TW11 are both arranged adjacent to the gap 205, and both the first end and the second end of the high-voltage winding TW21 are arranged adjacent to the gap 206. The high-voltage winding TW11 runs from the first end (SWH1_1) to the second end (SWH2), and first, in a first layer 111, it is wound a half turn clockwise along the first magnetic column 211, then wound one turn around the second magnetic column 212 counterclockwise, and then reaches a second layer 112 through a second via VH2; and on the second layer 112, it is wound one turn around the second magnetic column 212 in a counterclockwise direction, then wound one turn around the first magnetic column clockwise, and then returns to the first layer 111 through a first via VH1; and on the first layer 111, it is wound a half turn around the first magnetic column 211 in a clockwise direction to reach the second end (SWH2). The high-voltage winding TW21 runs from the first end (SWH3_1) to the second end (SWH4), and first, in the first layer 111, it is wound a half turn counterclockwise around the third magnetic column 213, and then reaches the second layer 112 through a third via VH3; and in the second layer 112, it is wound one turn around the third magnetic column 213 counterclockwise, then wound one turn around the fourth magnetic column 214 clockwise, and returns to the first layer 111 through a fourth via VH4; and in the first layer 111, it is wound one turn around the fourth magnetic column 214 in a clockwise direction, and then wound a half turn around the third magnetic column 213 counterclockwise to reach the second end (SWH4). The high-voltage winding TW11 is wound around the first magnetic column 211 and the second magnetic column 212, and the winding directions of the high-voltage winding TW11 on the first magnetic column 211 and the second magnetic column 212 are opposite; the high-voltage winding TW21 is wound around the third magnetic column 213 and the fourth magnetic column 214, and the winding directions on the third magnetic column 213 and the fourth magnetic column 214 are opposite; furthermore, the winding direction of the high-voltage winding TW11 on the first magnetic column 211 and the winding direction of the high-voltage winding TW21 on the third magnetic column 213 are opposite; the winding direction of the high-voltage winding TW11 on the second magnetic column 212 and the winding direction of the high-voltage winding TW21 on the fourth magnetic column 214 are opposite. The winding directions of the high-voltage winding on the two adjacent magnetic columns are opposite, and the magnetic flux flowing through the upper magnetic cover 221 and the lower magnetic cover 222 can cancel each other, thereby reducing the thickness of the magnetic cover and further reducing the thickness of the power conversion apparatus.

The winding manner of the low-voltage winding TW12 and the TW22 is as shown in FIG. 3B, the first end (SWL1) and the second end (SWL2) of the low-voltage winding TW12 are both arranged adjacent to the second side 202, and the first end (SWL1) is arranged between the first magnetic column 211 and the second magnetic column 212, and the two second ends (SWL2) are respectively arranged adjacent to the first side 211 and the third side 213. The first end (SWL3) and the second end (SWL4) of the low-voltage winding TW22 are both arranged adjacent to the fourth side 204, and the first end (SWL3) is arranged between the third magnetic column 213 and the fourth magnetic column 214, and the two second ends (SWL4) are respectively arranged adjacent to the first side 211 and the third side 213. On the third layer 113 of the substrate 10, the low-voltage winding TW12 is from the first end (SWL1) to the second end (SWL2), wound one turn first from a position between the first magnetic column 211 and the second magnetic column 212 in opposite directions around the first magnetic column 211 and the second magnetic column 212 respectively, that is, winding one turn around the first magnetic column 211 in a clockwise direction, and winding one turn around the second magnetic column 212 in a counterclockwise direction. The low voltage winding TW22 is from the first terminal (SWL3) to the second terminal (SWL4) ), wound one turn first from a position between the third magnetic column 213 and the fourth magnetic column 214 around the third magnetic column 213 and the fourth magnetic column 214 in opposite directions respectively, that is, one turn is wound around the third magnetic column 213 in a counterclockwise direction, and one turn is wound around the fourth magnetic column 214 in a clockwise direction. The winding directions of the low-voltage winding on the two adjacent magnetic columns are opposite, and the magnetic flux flowing through the upper magnetic cover and the lower magnetic cover can cancel each other, thereby reducing the thickness of the magnetic cover and further reducing the thickness of the power conversion apparatus. In other embodiments, the network of the first end (SWL1) of the low voltage winding TW12 can also be connected together, and similarly, the network of the first end (SWL3) of the low voltage winding TW22 can be connected together, thereby further reducing the parasitic resistance on the low voltage winding. The winding direction herein is defined as the winding direction from the first end to the second end of the winding.

In the present embodiment, the high-voltage winding is wound only one turn on each magnetic column of each layer; in other embodiments, the high-voltage winding may also be wound around two or more turns on each magnetic column of each layer, thereby increasing the step-down ratio of the input voltage to the output voltage. In other embodiments, the first end and the second end of the high-voltage winding can also be placed on different wiring layers, and can be modified according to the actual design, as long as the winding directions of the high-voltage winding on two adjacent magnetic columns are opposite. In the present embodiment, the low-voltage winding is wound on the same layer of the substrate; in other embodiments, the low-voltage winding may be wound on two or more layers, and the low-voltage windings on each layer are connected in parallel, thereby reducing the parasitic resistance on the low-voltage winding, reducing the transmission loss of the low-voltage winding, and improving the conversion efficiency of the power conversion device. On the other hand, the first layer, the second layer, and the third layer herein represent only different wiring layers, and are independent of the arrangement order of the wiring layers.

FIG. 3C is another structure of the magnetic core assembly and another winding method of the high-voltage winding TW11 and TW21. In the present embodiment, in order to facilitate wiring, and further improve the heat dissipation of the winding, the first side column 215 is divided into two parts: a first sub-side column 215a and 215b. A gap 205 exists between the first sub-side column 215a and the second side 202, a gap 206 exists between the first sub-side column 215a and the first sub-side column 215b, and a gap 207 exists between the first sub-side column 215b and the fourth side 204. The first end (SWH1_1) and the second end (SWH2) of the high-voltage winding are both arranged adjacent to the gap 205, and both ends of the high-voltage winding TW11 are connected to other components through the gap 205; the first end (SWH3_1) and the second end (SWH4) of the high-voltage winding TW21 are both arranged adjacent to the gap 206, and both ends of the high-voltage winding TW21 are connected to other components through the gap 206. The second side column 216 may also be divided into two sub-portions as the first side column 215, and also have the same features and technical effects. In the present embodiment, the area of the cross sections of the two first sub-columns is equal to the best, and the area of the cross sections of the two second sub-columns is equal to the best.

The present application discloses a power conversion device, which uses the circuit schematic shown in FIG. 1 and the control timing as shown in FIG. 2. The three-dimensional structure diagram of the power conversion device is shown in FIG. 4A to FIG. 4C. FIG. 4A is a top view of a three-dimensional structure of the power conversion device, FIG. 4B is a bottom view of the three-dimensional structure of the power conversion device, and FIG. 4C is an exploded view of the power conversion device. The power conversion device comprises a substrate 10, the substrate 10 comprising an upper surface 101 and a lower surface 102 opposite to each other, and the substrate 10 is a multilayer printed circuit board. The substrate 10 further comprises hole grooves121, 122, 123, 124, 125 and 126; all the hole grooves penetrate the upper surface 101 and the lower surface 102, and respectively serves the magnetic columns 211, 212, 213 and 214 and the side columns 215 and 216 to pass through; the upper magnetic cover 221 and the lower magnetic cover 222 assemble the substrate 10 from the upper surface 101 and the lower surface 102, respectively, providing a magnetic path for the windings disposed within the substrate 10.

In the present embodiment, the switches Q1 to Q8 in the high-voltage unit are all disposed adjacent to the first side 201 of the magnetic core assembly; furthermore, the switches Q1, Q2, Q5 and Q6 in the high-voltage full-bridge unit 1a are disposed adjacent to the gap 205, that is, adjacent to both ends of the high-voltage winding TW11; and the switches Q3, Q4, Q7 and Q8 in the high-voltage full-bridge unit 1b are disposed adjacent to the gap 206, that is, adjacent to two ends of the high-voltage winding TW21. The switches Q1, Q2, Q3 and Q4 are sequentially arranged along the first side 201 from the second side 202 to the fourth side 204 into a first column of high voltage switches, and the switches Q5, Q6, Q7 and Q8 are also sequentially arranged in the direction from the second side 202 to the fourth side 204 along the first side 201 into a second column of high voltage switches. Switches SR1 to SR4 in the low-voltage full-bridge unit 2a are disposed adjacent to the second side 202, and switches SR5 to SR8 in the low-voltage full-bridge unit 2b are disposed adjacent to the fourth side 204. Further, each lower switch is two identical switches connected in parallel; the lower switch in the low-voltage full-bridge unit 2a is arranged in a direction from the middle of the second side 202 to the first side 201 and the third side 203 respectively according to the order of SR1, SR2, SR3 and SR4, that is, the lower switches SR1 and SR2 are arranged adjacent to the first ends (SWL1) of the low-voltage windings TW12, and the lower switches SR3 and SR4 are arranged adjacent to the second ends (SWL2) of the low-voltage windings TW12; the lower switches in the low-voltage full-bridge unit 2b are arranged in a direction from the middle of the fourth side 204 to the first side 201 and the third side 203 according to the order of SR5, SR6, SR7 and SR8, respectively, that is, the lower switches SR5 and SR6 are arranged adjacent to the first ends (SWL3) of the low-voltage windings TW22, and the lower switches SR7 and SR8 are arranged adjacent to the second ends (SWL4) of the low-voltage windings TW22. The resonant capacitor C1 is arranged between the switch in the high-voltage full-bridge unit 1a and the first side 201 of the magnetic core assembly, and is arranged adjacent to the gap 205; the resonant capacitor C2 is arranged between the switch in the high-voltage full-bridge unit 1b and the first side 201 of the magnetic core assembly, and is arranged adjacent to the gap 206. The input terminal Vin is disposed adjacent to the switch of the high-voltage full-bridge unit; and the output terminal Vo is disposed adjacent to the third side 203 of the magnetic core assembly.

Referring to FIG. 4B, the input capacitors Cin1 and Cin2 are disposed between the first side 201 of the magnetic core assembly and the input terminal Vin, and the input capacitors Cin1 and Cin2 are respectively adjacent to the switches in the high-voltage full-bridge unit 1a and the switch in the high-voltage full-bridge unit 1b. The output capacitor Co is disposed on the second side 202 and the fourth side 204 of the magnetic core assembly, respectively, and the output capacitor Co is disposed adjacent to the switch in the low voltage circuit unit.

In the present embodiment, the switches in the high-voltage full-bridge unit and the switches in the low-voltage full-bridge unit are all arranged on the upper surface 101 of the substrate 10; the input capacitor Cin1 and Cin2 and the output capacitor Co are all disposed on the lower surface 102 of the substrate 10; but not limited thereto, in other embodiments, some of the switches of the two high-voltage full-bridge units may also be arranged on the lower surface 102 of the substrate 10, or some of the capacitors of the input capacitor Cin1 and/or Cin2 are arranged on the upper surface 101 of the substrate 10, as long as the input capacitor Cin1 and the switches in the high-voltage full-bridge unit 1a are guaranteed to be placed nearby, or projections on the same horizontal plane of the input capacitor Cin1 and the switches in the high-voltage full-bridge unit 1a at least partially overlap; the input capacitor Cin2 is placed adjacent to the switches in the high-voltage full-bridge unit 1b, or projections on the same horizontal plane of the input capacitor Cin2 and the switches in the high-voltage full-bridge unit 1b are at least partially overlapped, thereby shortening the connection path between the devices, further reducing the loss of the power conversion device, and reducing the volume of the power conversion device. On the other hand, in other embodiments, some of the switches of the two low-voltage full-bridge units may also be arranged on the lower surface 102 of the substrate 10, or some of the capacitors of the output capacitor Co are arranged on the upper surface 101 of the substrate 10, as long as it is ensured that the output capacitor Co is placed adjacent to the switch in the low-voltage full-bridge unit, or the projections on the same horizontal plane of the output capacitor Co and the switches in the corresponding low-voltage full-bridge unit at least partially overlap; in this way, the connection path between the devices is shortened, the loss of the power conversion device is further reduced, and the volume of the power conversion device is reduced.

The magnetic column (the side column and the middle column) in the transformer magnetic core or the inductor magnetic core disclosed in the present application can be independently formed with each of the two magnetic substrates, can also be integrally formed with one of the magnetic substrates, or divide each magnetic column into two parts, and each part is integrally formed with one magnetic substrate; and both the transformer magnetic core material and the driving magnetic core material can be ferrite. The cross section of the magnetic column connected to the magnetic substrate and the cross section of the magnetic substrate of the transformer magnetic core or the inductive magnetic core may be rectangular, square, circular or oval, etc. and are not limited thereto.

The switch disclosed by the application can be used for realizing the functions of the switch disclosed by the application, such as a Si MOSFET, SiC MOSFET, GaN MOSFET or IGBT MOSFET.

The power conversion device according to the embodiment can be an independent module or a part of the power supply module, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A high-power power conversion device, comprising a high-voltage unit, a low-voltage unit, an input capacitor, an output capacitor, an input positive terminal, an input negative terminal, an output positive terminal and an output negative terminal, wherein the high-voltage unit comprises a first high-voltage unit and a second high-voltage unit, the low-voltage unit comprises a first low-voltage unit and a second low-voltage unit, and the input capacitor comprises a first input capacitor and a second input capacitor;
each high-voltage unit comprises a switch and a high-voltage winding; the two high-voltage windings are respectively a first high-voltage winding and a second high-voltage winding; each low-voltage unit comprises a switch and a low-voltage winding; the two low-voltage windings are respectively a first low-voltage winding and a second low-voltage winding; the two high-voltage windings and the two low-voltage windings are coupled by means of a same magnetic core assembly;
the first high-voltage unit and the second high-voltage unit are electrically connected in series to an input midpoint, and the two high-voltage units are connected in series and then connected across the input positive terminal and the input negative terminal; the first input capacitor and the first high-voltage unit are connected in parallel and then connected across the input positive terminal and the input midpoint, and the second input capacitor and the second high-voltage unit are connected in parallel and then connected across the input midpoint and the input negative terminal;
the first low-voltage unit and the second low-voltage unit are electrically connected in parallel between the output positive terminal and the output negative terminal; the output capacitor is connected across the output positive terminal and the output negative terminal;
the power conversion device further comprises a substrate, the substrate comprising an upper surface and a lower surface opposite to each other; the substrate further comprises a plurality of hole grooves, the plurality of hole grooves penetrate the upper surface and the lower surface; the magnetic core assembly comprises a magnetic column, a side column, an upper magnetic cover and a lower magnetic cover; the magnetic column and the side column respectively pass through the plurality of hole grooves, and the upper magnetic cover and the lower magnetic cover are respectively assembled to the substrate from the upper surface and the lower surface; the magnetic core assembly further comprises a first side and a third side opposite to each other, and a second side and a fourth side opposite to each other;
the switch in the high voltage unit is disposed adjacent to the first side of the magnetic core assembly, the switch in the first low voltage unit is disposed adjacent to the second side of the magnetic core assembly, and the switch in the second low voltage unit is disposed adjacent to the fourth side of the magnetic core assembly.

2. The high-power power conversion device of claim 1, wherein two ends of each of the high-voltage windings are disposed adjacent to the first side of the magnetic core assembly; the switch and both ends of the low-voltage winding in the first low-voltage unit are disposed adjacent to the second side of the magnetic core assembly, and the switch and both ends of the low-voltage winding in the second low-voltage unit are disposed adjacent to the fourth side of the magnetic core assembly.

3. The high-power power conversion device of claim 1, wherein the magnetic column comprises a first magnetic column, a second magnetic column, a third magnetic column and a fourth magnetic column; the side column comprises a first side column and a second side column, the first side column is arranged adjacent to the first side of the magnetic core assembly, and the second side column is arranged adjacent to the third side of the magnetic core assembly; the four magnetic columns are arranged between the first side column and the second side column in a 2 ×2 array; the first magnetic column and the third magnetic column are arranged adjacent to the first side column, the second magnetic column and the fourth magnetic column are arranged adjacent to the second side column, the first magnetic column and the second magnetic column are arranged adjacent to the second side of the magnetic core assembly, and the third magnetic column and the fourth magnetic column are arranged adjacent to the fourth side of the magnetic core assembly.

4. The high-power power conversion device of claim 3, wherein a first end of the first low-voltage winding is arranged between the first magnetic column and the second magnetic column, a second end of the first low-voltage winding is respectively provided between the first side column and the first magnetic column, and between the second side column and the second magnetic column; and the first low-voltage winding is wound around the first magnetic column and the second magnetic column in opposite directions from the first end to the second end, respectively; a first end of the second low-voltage winding is arranged between the third magnetic column and the fourth magnetic column, a second end of the second low-voltage winding is respectively arranged between the first side column and the third magnetic column, and between the second side column and the fourth magnetic column, and the second low-voltage winding is wound around the third magnetic column and the fourth magnetic column in opposite directions from the first end to the second end, respectively; the winding direction of the first low voltage winding from the first end to the second end around the first magnetic column is opposite to the winding direction of the second low voltage winding from the first end to the second end around the third magnetic column.

5. The high-power power conversion device of claim 4, wherein the substrate comprises a plurality of wiring layers; the first high-voltage winding is wound at least two turns around the first magnetic column and the second magnetic column in opposite directions from the first end to the second end, respectively; the second high-voltage winding is wound at least two turns around the third magnetic column and the fourth magnetic column in opposite directions from the first end to the second end, respectively; the winding direction of the first high-voltage winding on the first magnetic column and the winding direction of the second high-voltage winding on the third magnetic column are opposite.

6. The high-power power conversion device of claim 5, wherein the high-voltage winding is wound at least two layers, the first high-voltage winding from the first end to the second end is first wound half turn clockwise around the first magnetic column in a first layer, and then wound one turn counterclockwise around the second magnetic column, and then reached the second layer through a second via; and on a second layer, it is first wound one turn around the second magnetic column in a counterclockwise direction, then wound one turn clockwise around the first magnetic column, and then returned to the first layer through a first via; and on the first layer, it is wound a half turn clockwise around the first magnetic column to reach the second end; the second high-voltage winding from the first end to the second end is first wound a half turn counterclockwise around the third magnetic column in the first layer, and then reached the second layer through a third via; and in the second layer it is wound one turn around the third magnetic column in a counterclockwise direction, then wound one turn clockwise around the fourth magnetic column, and then returned to the first layer through a fourth via, and on the first layer it is wound one turn clockwise around the fourth magnetic column, and then is wound a half turn around the third magnetic column counterclockwise back to the second end.

7. The high-power power conversion device of claim 5, wherein the two high-voltage windings are disposed on two layers of the plurality of wiring layers, and two ends of the two high-voltage windings are disposed on different wiring layers.

8. The high-power power conversion device of claim 2, wherein the switch in each high-voltage unit comprises a first upper switch, a second upper switch, a first middle switch and a second middle switch, and each high-voltage unit further comprises a resonant capacitor, the resonant capacitors are a first resonant capacitor and a second resonant capacitor; in the first high-voltage unit, the first upper switch and the first middle switch are electrically connected in series to a first upper node, and are connected in series between the input positive terminal and the input midpoint, the second upper switch and the second middle switch are electrically connected in series to a second upper node and are connected in series between the input positive terminal and the input midpoint, the first resonant capacitor and a first end of the first high-voltage winding are connected in series, and then connected in series between the first upper node and the second upper node, and a second end of the first high-voltage winding is electrically connected to the second upper node; in the second high-voltage unit, the first upper switch and the first middle switch are electrically connected in series to a third upper node, and are connected in series between the input midpoint and the input negative terminal, the second upper switch and the second middle switch are electrically connected in series to a fourth upper node, and are connected in series between the input midpoint and the input positive terminal, the second resonant capacitor and a first end of the second high-voltage winding are connected in series, and are connected in series between the third upper node and the fourth upper node, and a second end of the second high-voltage winding is electrically connected to the fourth upper node.

9. The high-power power conversion device of claim 8, wherein the switch in each of the low-voltage units comprises a first lower switch, a second lower switch, a third lower switch, and a fourth lower switch; in the first low-voltage unit, the first lower switch and the second lower switch are electrically connected in series to a first lower node, and are connected in series between the output positive terminal and the output negative terminal; the third lower switch and the fourth lower switch are electrically connected in series to a second lower node, and are connected in series between the output positive terminal and the output negative terminal; a first end of the first low-voltage winding is electrically connected to the first lower node, and a second end of the first low-voltage winding is electrically connected to the second lower node; in the second low-voltage unit, the first lower switch and the second lower switch are electrically connected in series to a third lower node, and are connected in series between the output positive terminal and the output negative terminal; the third lower switch and the fourth lower switch are electrically connected in series to a fourth lower node, and are connected in series between the output positive terminal and the output negative terminal; a first end of the second low-voltage winding is electrically connected to the third lower node; and a second end of the second low-voltage winding is electrically connected to the fourth lower node.

10. The high-power power conversion device of claim 9, further comprising a first control signal, a second control signal, a third control signal and a fourth control signal, wherein the duty ratios of the first control signal and the second control signal are both 50% with a phase shift of 180 degrees; the third control signal is complementary to the first control signal, and the fourth control signal is complementary to the second control signal.

11. The high-power power conversion device of claim 10, wherein the first control signal is used for controlling turn-on and turn-off of the first upper switch and the second middle switch of the two high-voltage units; the second control signal is used for controlling turn-on and turn-off of the second upper switch and the first middle switch in the two high-voltage units; the third control signal is used for controlling turn-on and turn-off of the second lower switch and the third lower switch of the two low-voltage units; the fourth control signal is used for controlling turn-on and turn-off of the first lower switch and the fourth lower switch in the two low-voltage units.

12. The high-power power conversion device of claim 10, wherein the second end of each high-voltage winding and the second end of each low-voltage winding have the same polarity.

13. The high-power power conversion device of claim 8, wherein the first resonant capacitor is disposed between the switch in the first high-voltage unit and the first side of the magnetic core assembly, and the second resonant capacitor is disposed between the switch in the second high-voltage unit and the first side of the magnetic core assembly.

14. The high-power power conversion device of claim 1, wherein the first high-voltage unit is connected across the input positive terminal and the input midpoint, and the second high-voltage unit is connected across the input midpoint and the input negative terminal; the first input capacitor is disposed adjacent to the switch in the first high-voltage unit, and the second input capacitor is disposed adjacent to the switch in the second high-voltage unit.

15. The high-power power conversion device of claim 1, wherein the switch in the two high-voltage units are disposed on the upper surface of the substrate, and the first input capacitor and the second input capacitor are disposed on the lower surface of the substrate; projections on the same horizontal plane of the first input capacitor and the switch in the first high-voltage unit are at least partially overlapped, and projections on the same horizontal plane of the second input capacitor and the switch in the second high-voltage unit are at least partially overlapped.

16. The high-power power conversion device of claim 1, wherein a part of the switches of the two high-voltage units is arranged on the upper surface of the substrate, and another part of the switches of the two high-voltage units is arranged on the lower surface of the substrate.

17. The high-power power conversion device of claim 1, wherein the switch of the two low-voltage units is arranged on the upper surface of the substrate, and the output capacitor is arranged on the lower surface of the substrate; and projections on the same horizontal plane of the output capacitor and the switch in each of the low-voltage units are at least partially overlapped.

18. The high-power power conversion device of claim 1, wherein a part of the switches of the two low-voltage units is arranged on the upper surface of the substrate, and another part of the switches of the two low-voltage units is arranged on the lower surface of the substrate.

19. The high-power power conversion device of claim 1, further comprising a power input and a power output, wherein the power input is disposed adjacent to the switch in the high-voltage unit, and the power output is disposed adjacent to the third side of the magnetic core assembly.

20. The high-power power conversion device of claim 3, wherein a first gap exists between the first side column and the second side of the magnetic core assembly, the switch in the first high voltage unit is arranged adjacent to the first gap, and two ends of the first high voltage winding are electrically connected to the switch in the first high voltage unit through the first gap; a second gap exists between the first side column and the fourth side of the magnetic core assembly, the switch in the second high voltage unit is disposed adjacent to the second gap, and two ends of the second high voltage winding are electrically connected to the switch in the second high voltage unit through the second gap.

21. The high-power power conversion device of claim 3, wherein the first side column comprises two first sub-side columns, a first gap exists between the second side of the magnetic core assembly and an adjacent first sub-side column, the switch in the first high-voltage unit is arranged adjacent to the first gap, and two ends of the first high-voltage winding are electrically connected to the switch in the first high-voltage unit through the first gap; a second gap exists between the two first sub-side columns, the switch in the second high-voltage unit is arranged adjacent to the second gap, and two ends of the second high-voltage winding are electrically connected to the switch in the second high-voltage unit through the second gap.

22. The high-power power conversion device of claim 9, wherein the first lower switch, the second lower switch, the third lower switch, and the fourth lower switch in each low-voltage unit comprise two switches electrically connected in parallel respectively, and the first lower switch, the second lower switch, the third lower switch and the fourth lower switch in each low-voltage unit are sequentially arranged from the middle of the second side or the fourth side to the first side and the third side.

23. The high-power power conversion device of claim 9, wherein the switches in the first low-voltage unit are disposed along the second side of the magnetic core assembly, the switches in the second low-voltage unit are disposed along the fourth side of the magnetic core assembly.
